(19) United States
(12) Patent Application Publication
(10) Pub. No.: US 2013/0227520 A1
(43) Pub. Date: Aug. 29, 2013

(54) Rapid process integration through visual integration and simple interface programming

(71) Applicant: Eric Keith Hosick, Santa Cruz, CA (US)

(72) Inventor: Eric Keith Hosick, Santa Cruz, CA (US)

(73) Assignee: Eric Hosick, Santa Cruz, CA (US)

(21) Appl. No.: 13/199,482

(22) Filed: Sep. 1, 2011

(51) Int. Cl. G06F 9/44

(52) U.S. Cl. CPC G06F 8/315
USPC 717/108

(57) ABSTRACT

In a first aspect, the invention features a method. A method of simplifying object interaction comprises defining objects whose public interface contains only properties; creating structured data objects; locating references to objects in the structured data object; associating said structured data object with at least one thread; locating said references; initializing said objects; accessing said objects; wherein said objects are persist-able; wherein said properties contain values or locators containing a reference to values.

### TECHNICAL FIELD

The invention is generally related to computing devices and computer software. More specifically, the invention is generally related to programming languages and computer management of dynamic logical entities such as objects and the like and communication between these dynamic entities through visual integration as opposed to programmatic integration.

### BACKGROUND

Translating human knowledge into computerized form to enable a computer to perform a useful task is a difficult problem that has existed since the advent of computers. Humans tend to think in terms of abstract concepts and the meanings behind such concepts. Computers are more literal in nature expecting specific inputs and outputting specific responses to such inputs. To bridge the gap between humans that desire to perform tasks, and the computers that ultimately perform those tasks, skilled software programmers are required to develop computer programs that minimize the level of skill required by end users. Whereas, at the beginning of the computer revolution, computer programs were rudimentary in nature, and required extensive skill on the part of end users, computer technology has now evolved to the point that computer programs are much more complex, often making computers much simpler to use. In addition, new development tools are constantly being developed to relieve the burden on software programmers so that, rather than having to construct a computer program from the ground up, the software programmer can rely on pre-existing components to impart high-level functionality to a computer program.

As a result of these advancements, the level of skill required to both develop and use computer programs continues to decrease. Consequently, computer technology has become more useful to a wider number of people. Reducing the level of skill required to both develop and use computer programs allows persons knowledgeable of the problems faced in a business environment to have more control over the development of the program rather than leaving those duties to a software programmers who are most likely not as knowledgeable of such problems in a given business domain. However, as computers become more powerful and main stream, the expectations of what computers should be capable of doing also increase. As such, there is always a demand for even more skilled labor to provide software to solve more complex problems and provide for the needs of the user.

Process behavior can vary greatly between different domains of business, i.e. sales process of coal vs. shoes, or between companies, i.e. sales process of software as conducted by Apple vs. Microsoft, and even by the state of an entity, i.e. attacking a monster as a warrior vs. as a wizard in a video game. Further, a process can easily change at the whim of those who define the process. This makes the modeling and implementation of rapidly changing process very difficult using object-oriented modeling and programming.

Merriam Webster defines an entity as “something that has separate and distinct existence and objective or conceptual reality”. In object orient modeling or object oriented programming (“OOM/OOP”), entity-objects are classes which encapsulate the properties and behavior of real world discernible entities like product lines, departments, warehouses, pens, trucks, etc. A specific example of an entity-object is a pen, which has the attributes of size, color, shape and behavior such as the ability to transfer ink to paper. What makes a pen a pen, even in different environments such as business, games, simulations, etc., does not change.

OOP is effective at modeling entities because entities are easily discernible, generally static and rarely change. OOP with intrinsic features such as abstraction, inheritance, generalization and encapsulation works well with entity objects because it was designed to do so.

Generally in OOP objects interact through their public interface: the accessible parts of an object. To effectively model a dynamic changing process, changes to an object's interface are most likely made. However changes to an object's interface can result in adverse effects such as cascading changes throughout a software program. In addition changes to an objects interface need to be done through language syntax at the source code level. Since the changes are done at the source code level by people who have knowledge of software engineering, and not by people with the domain knowledge, these changes are often difficult to implement and can lead to increased costs and wasted time.

Attempts have been made to describe the interaction between objects outside of source code. Moving object interaction to the software architecture level allows for rapid change of (business) processes without expensive re-engineering at the programming language level. However, such attempts have led to architectures that are complex, highly specialized, domain specific, bulky and non-standardized. Examples of attempts to do this are SAP, Cobra/Orb, PeopleSoft, etc. Typically, an entity-class designed for one architecture will, most likely, not work in other architectures as the entity-class becomes dependent on the proprietary architecture: the entity-class contains source code specific to that architecture so it can “communicate” with other entities classes contained within that same architecture.

Further, the IT industry has, for many decades, developed new ways to improve on the software development process. The IT industry has always had a goal of developing software system that are re-usable across different software projects being that a lot of time and money is invested in developing these systems. Among many developments are programming languages and methodologies of different flavors related to programming languages. Functional programming, structured programming and object-oriented programming are a few of the different flavors of programming that have been developed. But the process to get where we are today, with object-oriented programming being the main stream programming methodology, was a long one.

It is easier for people to understand and process information they receive if that information is broken down into small parts. The IT industry has always tried to write software with this basic concept in mind. The source-code of some of the earliest software programs programming languages were unstructured and did not naturally provide constructs to group together functional aspects of a computing system. Out of this unstructured programming methodology came structured programming.

In software engineering, information is stored in constructs known as variables. Variables can be of many different types including, but not limited to, bits, bytes, characters, integers, real number, decimal number, strings and arrays of these simple types. More complex information is stored in other constructs such as structures and objects which are discussed in more detail below. The term information, as used in Information Technology, refers to the data types used to store information within a computer system. Structured programming focuses on functions which are the main workhorse. In terms of information processing, functions contain the logic necessary to process information. The logic that process information within a function should be similar enough to warrant grouping that logic within a single function (it should be cohesive).

Functions process information within their “scope”. Information located outside of their scope is usually not accessed or processed by a function. To get information into a function, a parametric interface is created: a method signature. This method signature uses zero or more parameters that contain the information required by the logic contained within the function to derive a result. To get the results “out” of a function, the function can return data as a result or through the parameters passed to the function. The function does improve on bringing together similar functional units of source code into manageable logical units of work. For small units of work at a conceptually lower level, such as mathematic functions, the function is an excellent way of manipulating information using operative logic.

However, for units of work that process more complex information, functions do not work as well. This is because the communication of information with functions and storage of that information becomes more and more difficult as the structural complexity of the information increases: the method signature also becomes complex. This causes functions to become less effective as we attempt to group together smaller units of work into larger units of work. If the information being submitted to the function is complex then the method signature of the function must also be complex. Limited to simple data types, functions end up with a large number of parameters in their signature. An increase in complexity of a functions signature leads to a lot more overhead when a developer needs to make changes to the interface of functions.

In software engineering, developers are consistently changing the method signature of existing functions. Changing the signature of functions has side effects. Every place in the software that has already used the function has to be fixed or updated to support the new method signature of the function. This can lead to a domino effect when the developer has to update the method signature of other functions to support the new method signature of the function that was changed. With the introduction of structures, similar types of information represented with simple data types can be cohesively grouped together. When information becomes too complex to pass to functions on a parameter by parameter basis a developer is able to use structures. A function with a complex method signature, with many parameters, can be made simpler by passing structures to the function.

Grouping together similar information within structures and using those structures as parameters to functions is effectively hiding the structural complexity of the information from the method signature of the function. A change made to a structure will not affect the method signature of the function. Structured programming leads to programs with many functions. With so many functions, managing groups of functions that did processing on similar information becomes overwhelming. This also leads to one of the big problems with structured programming. Where does all the information that is manipulated get stored between calls to functions?

The next step in improving on software development and design methodologies was the introduction of object-oriented programming. Object-oriented programming introduces the concepts of objects. Objects are very similar to structures but, unlike structures, an object is able to contain functions, and thus operative logic, within the structure. Not only is the layout of complex information hidden “inside” objects but also the functions (called methods when they are part of an object) themselves are now grouped together. This provides advantages over structural programming. There is now a more effective way of communicating information between similar functions by grouping those functions within an object. There is also a place to store temporary information between calls to functions which are within the object itself. Objects lead to functions (now called methods) that have a simpler method signature than they had when developers used structures as parameters in functional programming. The simpler signature is possible because there is now an implied parameter (a “this” pointer) that allows access to all the information contained within the object.

Methods contain operative logic that generally requires information stored within the object itself. Objects also lead to information being located within the objects where the information is more “structured” than when only structural programming was used. However, objects still have interfaces (made up of method signatures and properties) and when those interfaces need to change, developers still have the same problems they had in structural programming. Further, object-oriented programming does not intrinsically contain any methodologies for managing information between objects at the program level nor does it provide developers with any consistent way of creating object interfaces. This leads to software that contains objects that are less re-usable.

There is no globally agreed upon architecture by which object may communicate information with each other and/or use each other. One of the primary reasons for a lack of a consistent and globally agreed upon architecture is due to the complex nature of objects and their interfaces. Because objects can have dynamic and complex interfaces, it is highly un-likely that two different companies will come up with the same process of communication between objects. It is even more un-likely that two companies could agree on a consistent architecture by which objects communicate within. This further leads to objects that are less re-usable. In the end, all of these advances are towards a goal of creating re-usable objects and this goal has not been reached.

Writing software is an expensive and time consuming process. Leveraging off of existing programs in highly desirable but often not attained. Although there has been a progression towards simpler method interfaces and more structured software development, object-oriented programming has stopped short of providing a well defined means and methods for creating consistent object interfaces and has stopped short of providing a consistent way of structuring information. Creating a consistent way of interfacing with objects is difficult at the very least. This is because there are as many ways to create an object's interface as there are real things in the real world. There are similarly just as many ways objects can communicate with each other as there are things in the real world.

Further, method signatures allow developers to create any type of interface they want. So, it is easy to end up with as many different interfaces to do the same thing as there are developers creating interfaces. Since a solution for solving the problem of creating consistent interfaces is difficult, a new direction to solve this problem is needed.

### Loose Coupling

Tightly coupled systems tend to exhibit the following developmental characteristics, which are often seen as disadvantages. A change in one module usually forces a ripple-effect of changes in other modules generating cross cutting concerns. The assembly of modules might require more effort and/or time due to the increased inter-module dependency. Thus a particular module might be harder to reuse and/or test because dependent modules must be included.

Loosely coupled systems tend to exhibit the following developmental characteristics, which are often seen as advantages. A change in one module usually does not force a ripple-effect of changes in other modules thus decreasing cross cutting concerns. The assembly of modules might require less effort and/or time due to the decreased inter-module dependency. Thus a particular module might be easier to reuse and/or test because dependent modules do not need to be included.

### Object Serialization and Persistence

Serialization is the process of saving and restoring objects: persisting objects. More precisely, serialization is the process of saving and restoring the current data and the data structures of objects. The information is extracted from objects so that it is not lost or destroyed. In other words, the transitory status of objects is fixed (often in a file or a database or in the internet cloud, etc.) for the purpose of storage or communications. This process is also called persistence.

If an application using an object is closed, then the object's data and its data structures must be persisted so that the object may be restored into its current state when the program is invoked again. For example, it is often necessary to temporarily store an object so that another application may access it. In another example, sending an object to another computer in a distributed computing environment requires the object be stored, transmitted, received, and recovered. In each of these examples, objects are stored and restored.

When serializing an object, the focus is not so much on how to store an object's data in non-volatile memory (such as a hard drive), but rather on how the in-memory data structure of an object differs from how the data appears once it has been extracted from the object. In memory, the data is located at arbitrary addresses, which are conceptually defined as data structures including data, arrays, objects, methods, and the like.

To store a data structure, it must be broken down into its component parts, which includes simple data types like integers, strings, floating point numbers, etc. In addition, the hierarchical arrangement within each data structure must be stored and maintained. Furthermore, the hierarchical arrangement of data structures themselves must be stored and maintained.

The serialized data of an object may be thought of as a “dehydrated object” where all of the water (object functions in this metaphor) has been squeezed out of the object. This leaves only dry potato flakes (the data). Later, a hungry person wishes to have mashed potatoes (the object with the data), the potato flakes may be rehydrated. To “add water” to a dehydrated object, an empty object is created and the stored data is inserted therein.

### Passing External Information

FIG. 1 depicts pseudo code for defining a class with properties and methods in an object-oriented programming language. The syntax itself differs between languages, but the idea is to declare a module (or section) of code that defines both properties and behavior of real world entities/objects. The module and/or section are defined by scope symbols: in the case of the pseudo code the symbols are “{” (for start scope) and “}” for stop scope. Pen 104 is a public Class 102 representing a pen. Public property 106 defines a property named p_color 110 of type Color 108 belonging to Pen 104 representing the color of a pen. Public property 112 defines a property named p_size 116 of type float 114 belonging to Pen 104 representing the size of the tip of a pen. Public property 118 defines a property named p_shape 122 of type Shape 120 belonging to Pen 104 representing the shape of the tip of a pen. Since a class represents a generalization of different entities or objects in the real world, the number of properties can vary from one to infinite. Pen 104 is just one such example of a real world entity.

A method is generally defined using a method name, return type and parameters, which comprises the method signature. Similar to the signature of a human, a method signature uniquely identifies/defines a method within the scope of a class and how that method is used. Still referring to FIG. 1, Method 124 defines transferInk 128 with result bool 126, is pseudo code that represents how behavior is defined within a program. transferInk 128 contains logic 140 that represents the steps the computer should take within the scope of transferInk 128. transferInk 128 has a method signature 130 made up of explicit parameter paper 134 of type Paper 132 and explicit parameter pressure 138 of type int 136. Methods have access to internal information, within the scope, of the class. In our example, transferInk 128 has access to the three properties p_color 110, p_size 116 and p_shape 122. Any other methods of Pen 104 would also have access to properties of Pen 104. This is because methods have an implied, automatic parameter, called this or self. The “this” parameter provides access to the properties of the class from within logic 140. Finally note that FIG. 1 is simply an example of one class of a plethora classes wherein each class can have a plethora of properties and methods.

An example of using a method with parameters is provided in FIG. 2. Using a method is done within another method. In this example TakeExam 202 is a public Class 102. TakeExam 202 has a method 204 named write 208 with result void 206. Write 208 is the example method which uses another method. Write 208 is defined with method signature 210 made up of explicit parameter pen 214 of type Pen 104, explicit parameter paper 218 of type Paper 216 and explicit parameter user 222 of type Person 220.

TransferInk 128 is a method of Pen 104 and is accessed through instance pen 214. Line 05 of FIG. 2 shows how to call method TransferInk 128. Each explicit parameter of TransferInk 128, paper 134 of type Paper 132 and pressure 138 of type int 136 must have a value provided. Explicit parameter paper 218 is mapped to paper 134. A method pressureUsed 224 is called on instance user 222 of type Person 220. The value returned by pressureUsed 224 is mapped to pressure 138 of type int 136.

Method transferInk 128 of Pen 104 returns a value bool 126 and that value is used by to determine if logic 226 should be called. When value bool 126 is true then logic 226 is executed. When value bool 126 is false then logic 226 is not executed. This is one example of a plethora of method signatures available in programming. A software engineering has to go through this process every time they want to call a method.

A challenging aspect of programming is updating method signatures and interfaces to accommodate changes, for example due to changing processes or business logic. Generally this requires updating all the relevant method signatures and/or interfaces. This leads to increased cross cutting concerns and generally hinders the development of fully modular source code. FIG. 3 depicts a conventional process of updating method signatures to accommodate changes.

In FIG. 3 transferInk 128 of Pen 104 is updated to reflect a change in the process where the temperature of the environment is required. TransferInk signature 306 of method TransferInk 304 of Pen 302 now has a new explicit parameter Env 310 of type Environment 308. Using the method transferInk 304 requires passing the new explicit parameter Env 310.

This requires a cascading update of all methods that use transferInk. As such, Write 208 of TakeExam 202 is also updated. The new Write Signature 316 of method Write 314 now has a new explicit parameter env 310 of type Environment 308. A cascading update takes place because Env 310 required by signature transferInk 306 must get the newly required information. The cascading update took place by adding Env 310 of type Environment 308 to Write signature 316 of Write 314. In this way, it is possible for the new temperature requirement to be passed to transferInk 304. In this case getTemp 318 of Environment 308 is called and the result temperature is passed to transferInk 304.

Since the interactions between TakeExam 312 and Pen 302 are defined through language syntax in the signature transferInk 306 and signature Write 316, changes will need to take place at the source code level. The magnitude of the problem can be appreciated by considering the increased cross cutting concerns of hundreds or even thousands of linked interfaces that require updating to reflect a change in process.

Due to an effectively infinite combination of object interfaces and interactions, industry wide standardization of object interaction is a difficult and daunting task. If it were possible to simplify the language syntax that describes an object's interface, then it would be possible to standardize object interaction without complex architectures. This would lead to loose coupling between object interfaces resulting in a more efficient way of modeling the dynamic and changing processes typically found in real world problems.

### SUMMARY OF INVENTION

In a first aspect, the invention features a method. A method of simplifying object interaction comprises defining objects whose public interface contains only properties; creating structured data objects; locating references to objects in the structured data object; associating said structured data object with at least one thread; locating said references; initializing said objects; accessing said objects; wherein said objects are persist-able; wherein said properties contain values or locators containing a reference to values.

An object's public interface is defined only using properties. Accordingly a greater degree of code-reusability and object modularity is achieved. In one aspect a method of simplifying object interaction comprises only using properties and therefore bypassing language syntax, parameters, for passing of information between objects.

Instead of methods with parameters, external information is stored in one or more data structures referred to as composite centric memory (“CCM”). In one aspect the CCM is a composite data structure. In a further aspect the location of object instances is confined to the CCM. CCMs contain all external information including locators capable of locating that information for the properties, which require external information. In still a further aspect the CCM is the structuring of object instances within a program.

In a second aspect, the invention features a visual graphical user interface method for development, integration and implementation of software applications and systems. A method of software implementation using aforementioned simplified object interaction; visually creating aforementioned structured data object; visually associating said structured data object with at least one thread; visually locating said references; visually initializing said objects; visually accessing said objects; visually associating object interaction; and visually executing object behavior.

### BRIEF DESCRIPTION OF THE DRAWINGS

For a more complete understanding of the present invention, reference is now made to the following detailed descriptions of a few representative presently preferred embodiments and to the accompanying drawings, in which:

FIG. 1 depicts pseudo code for defining a class with properties and methods in a conventional object-oriented programming language;

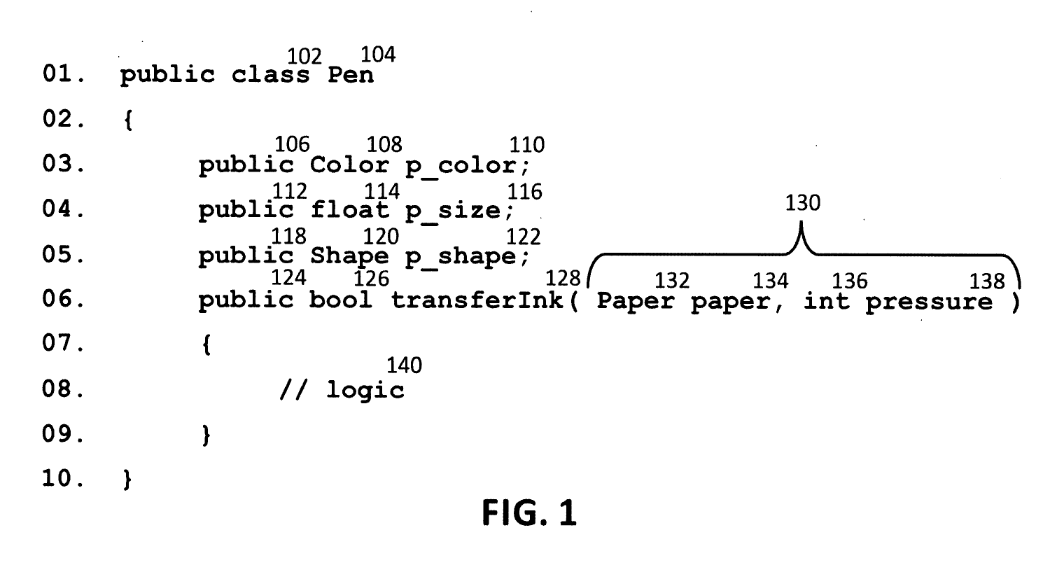

FIG. 2 depicts an example a conventional method with parameters;

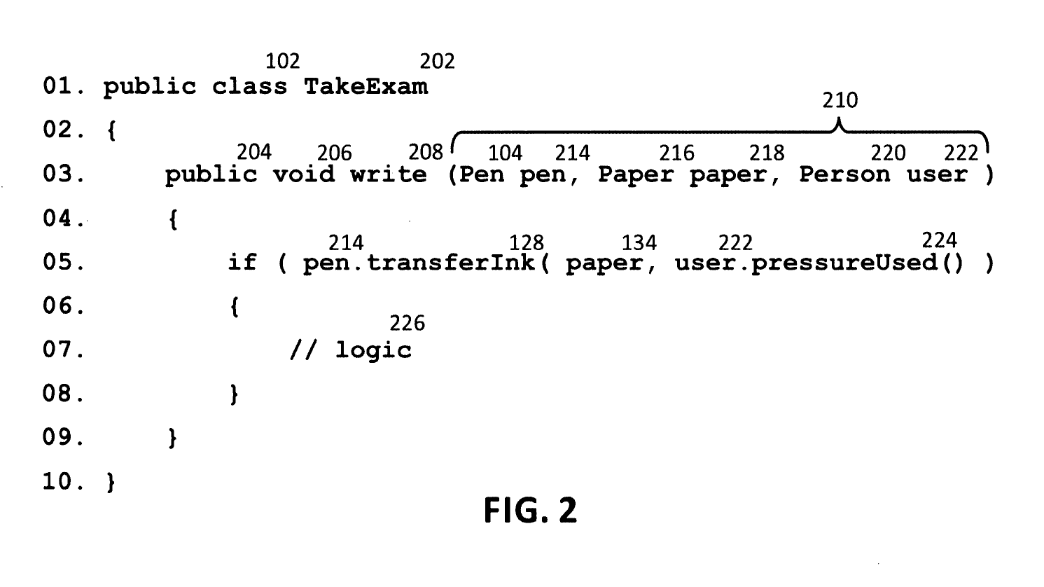

FIG. 3 depicts a conventional process of updating method signatures to accommodate changes in a software program;

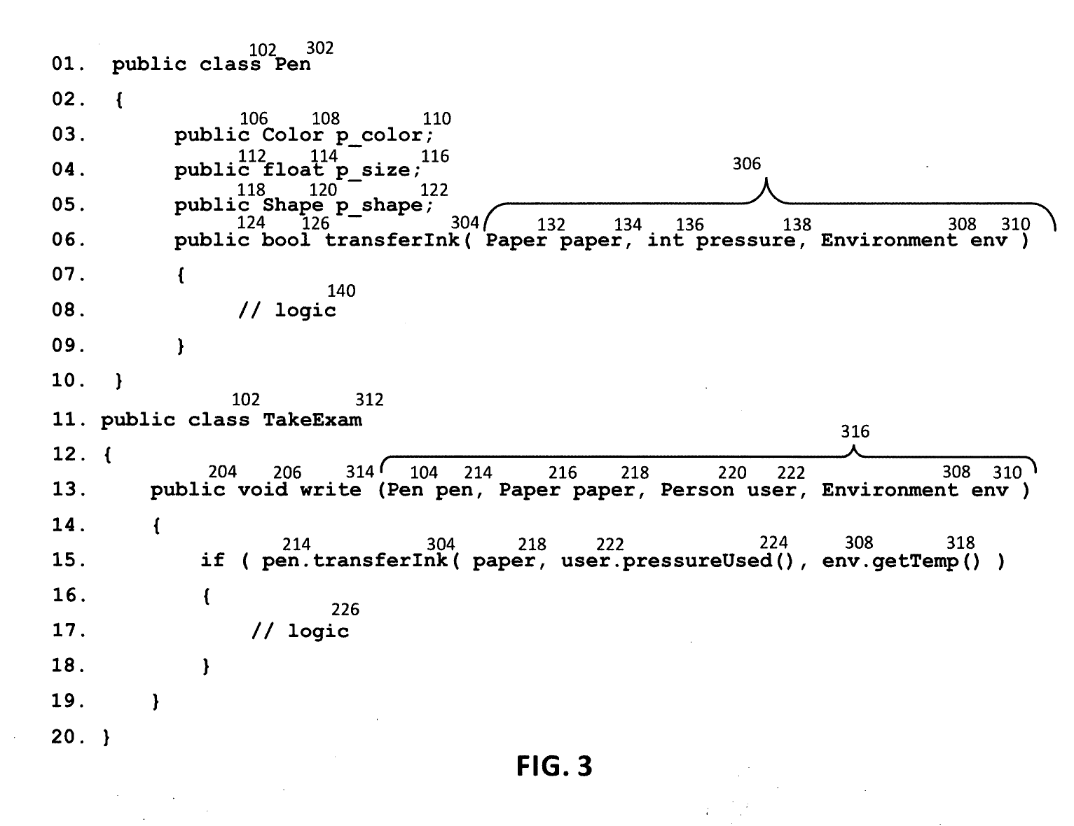

FIG. 4 shows how a thread may be associated with a CCM in accordance with the current invention using a thread manager;

FIG. 5 depicts an exemplary CCM called RootCCM;

FIG. 6 shows how a prior art pen may be represented using the current invention;

FIG. 7 shows how properties can store a value or the location of a value within the CCM;

FIG. 8 depicts an application of the methods discussed herein;

FIG. 9 depicts the RootCCM example of FIG. 5 in further detail;

FIG. 10 shows how the structure of an exemplary CCM may be described using XML;

FIG. 11 depicts another approach to accessing CCM;

FIG. 12 shows how a single reference to a CCM may be used to transfer external information;

FIG. 13 shows how external information may be passed to a method via a CCM instance utilizing a thread manager;

FIG. 14 shows how external information may be passed to a method using an implied parameter;

FIG. 15 depicts the mapping of a RootCCM with a current thread or process; and

FIG. 16 shows how the current invention may visually define a software system using simplified objects.

### DETAILED DESCRIPTION

As used herein interface means the parts of two or more system/entities/objects/classes which interact. Object refers to a class as opposed to an instance of the class. An object instance is an instance of a class. Entity-object means a class that represents real world entities. They are classes that encapsulate the business model or logic, including rules, data, relationships, and persistence behavior, for items that are used in a business application. Object interaction occurs when one object accesses and thus uses a property of another object. Composite centric memory is defined as logical memory contained within a computing system that has been ordered in a logical and structured manner (such as but not limited to lists, collections, composites, hashes, etc).

Implied parameter means any parameter that is not explicitly defined within a methods signature. For example the self/this/me pointer is an implied parameter. In C#, the value parameter of properties is an implied parameter. In some languages defaults for parameters, such as void foo (int age=0), is possible making age an implied parameter. As used herein, defaulted parameters are not implied parameters.

A property is defined as both a property or attribute. A property is not viewed as a method, even though a property has an implied parameter signature. In this case, a property has encapsulated this aspect of a method and as such it is ubiquitous: thus a property being perceived as a method is not interesting.

Using operators such as square brackets [ ] for accessing arrays and other composites are also not considered methods. In this case, the brackets abstract the idea of a method signature making it ubiquitous: thus brackets being perceived as a method is not interesting. The same holds for all operators within a programming language and the overriding of those operators. Again, the operator makes parameter lists ubiquitous and, as such, not interesting. Further, in some languages the new operator calls, at the very least, the empty constructor of a class. An empty constructor is automatically created during compilation of a class. As such, this is a side affect of some languages and does not count as a method herein.

This invention focuses on the publicly accessible aspects of an object: it's interface. Thus, private or protected methods of an object are not considered.

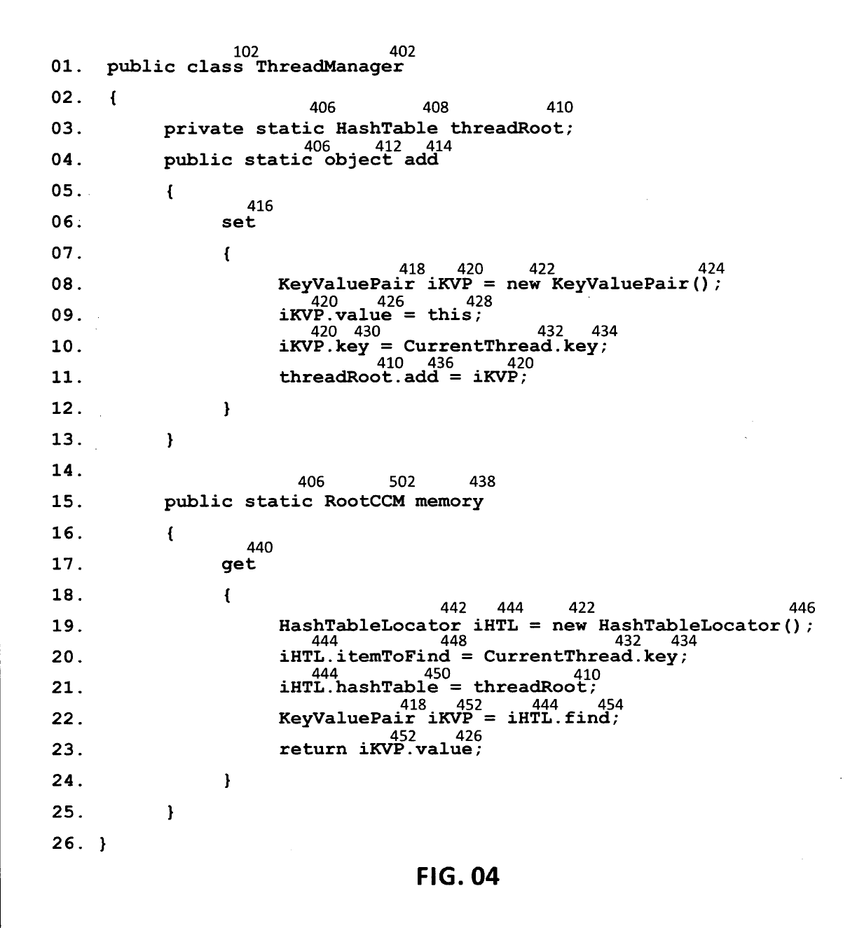

In another aspect each thread has one or more CCM instances associated with it. A thread is a stream of execution separate from other steams of execution. In a system with multiple central processing units, more than one thread can run on a computing device at the same time. Logic within a stream of execution is able to query which stream it belongs to at any point within the logic. When a thread is created, one or more CCMs can be created and attached to that thread. This means the CCM is indirectly accessible by first querying the current thread as shown in FIG. 4.

A CurrentThread 432 is associated with this 428 of type RootCCM 502 using ThreadManager 402 depicted in FIG. 4. ThreadManager 402 contains threadRoot 410 of type HashTable 408 which is a property that is static 406. A property marked as static means that the property can be accessed via ThreadManager 402 as opposed to an instance of ThreadManager 402. threadRoot 410 is a HashTable 408 associating the current operating system thread found using CurrentThread 432 with a RootCCM 502 instance. This is later used to find the associated RootCCM 502 with current thread 432.

Further, ThreadManager 402 supports associating a RootCCM 502 using the add 414 property of type object 412 and is also a property that is static 406. Add 414 adds a RootCCM 502 when set 416 scope is called during a set value operation with a program. The logic for set 416 is as follows. iKVP 420 of class KeyValuePair 418 is created using new 422 calling constructor 424. KeyValuePair 418 has properties value 426 and key 430. iKVP 420 has the value 426 set to this 428. This 428 is an instance of RootCCM 502. They key 430 of iKVP 420 is set to the key 424 of CurrentThread 432. The iKVP 420 is then added to threadRoot 410 by setting add 436 to iKVP 420. The threadRoot 410 now contains an association between CurrentThread 432 and RootCCM 502 instance this 428.

Further, to find the RootCCM 502 associated with CurrentThread 432 the property memory 438 is provided as part of ThreadManager 402. The property named memory 438 returns a RootCCM 502. Get 440 of memory 438 is called when using ThreadManager 402 in code within the program. The logic of finding the RootCCM of 502 for the CurrentThread 432 is as follows. iHTL 444 of type HashTableLocator 442 is created using constructor HashTableLocator( )446. HashTableLocator 442 contains properties itemToFind 448 which contains the name of the item to find within hashTable 450. itemToFind 448 of HashTableLocator 442 is set to key 434 of CurrentThread 432. The hash table which HashTableLocator 442 will search against is threadRoot 410. So, hashTable 450 of HashTableLocator 442 is set to threadRoot 410. iKVP 452 of type KeyValuePair 418 is then set to the KeyValuePair 418 returned when find 454 of HashTableLocator 442 is accessed. Finally, the value 426 which contains the RootCMM 502 instance is returned. This is how the RootCCM 502 of CurrentThread 432 is found.

Locaters are objects used to traverse and search for data and/or update data within a given type of CCM. Each CCM needs one or more locators. Non-limiting examples of locators include: xml locators which are able locate and update data within an xml centric CCM; mixed locators are able to locate and update data within a mixed CCM; composite locators are able to locate and update data within a composite centric CCM.

In one aspect, the locator is a design pattern that shifts the responsibility of returning a value in a composite from the composite to Locators. A design pattern in architecture and computer science is a formal way of documenting a solution to a design problem in a particular field of expertise. In still a further aspect, object instances are uniquely locatable in CCM using locator objects via a single unique key and/or position in a composite.

Further examples of locators include a database. A locator could be programmed to locate information from that memory. Similarly, in one embodiment, for a XML file that contains information, xQuery could be encapsulated as a locator to find information within an XML file.

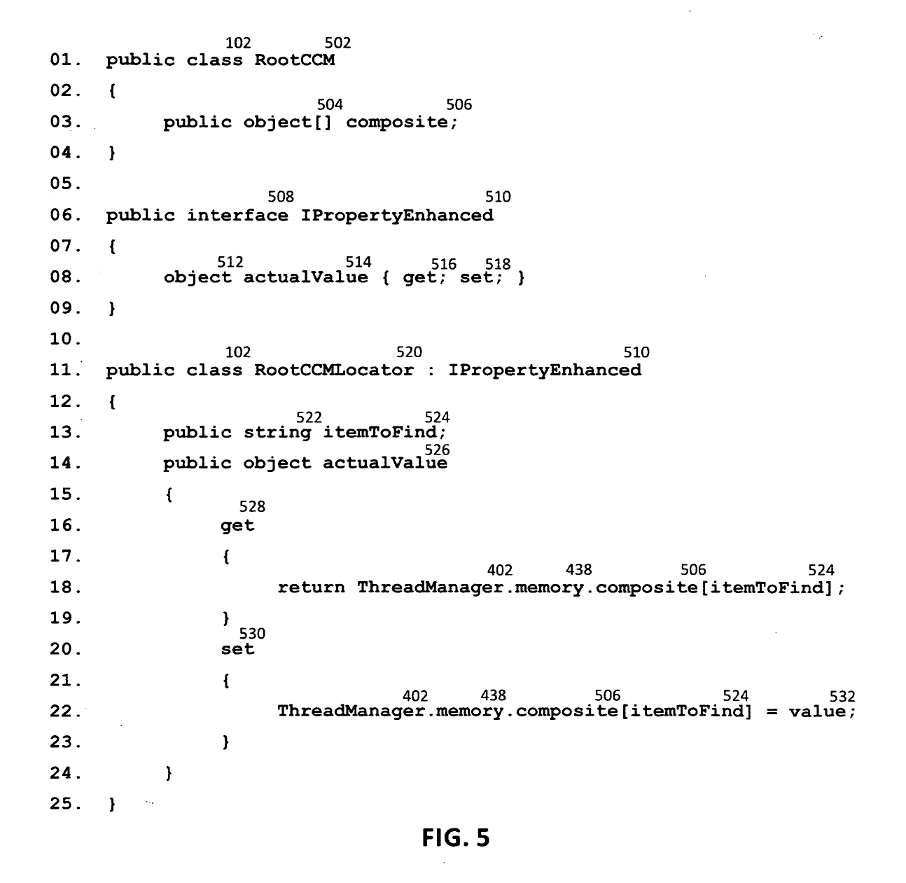

An exemplary CCM RootCCM 502 of a class 102 is depicted in FIG. 5. Generally, root CCM(s) are associated with one or more processes and/or threads which are accessible from any method as depicted in FIG. 4 and described above. In another aspect, CCM instances, which are also objects, are placed in the CCM. As such another CCM could be placed within the composite 506 of type object[ ] 504 allowing for stacking of different CCM types. RootCCM 502 declares an example public class 102 representing a starting point or root to composite centric memory. RootCCM 502 has a hierarchical structure and is the beginning of the CCM. Non-limiting examples of composite centric memory include aggregate centric, hash centric, Xml centric, Sql Centric, Document Object Model (DOM) centric, flat file centric, object database centric, CCM.

Typically, in most programming languages, a data structure has functionalities for storage and location of information contained in the data structure. Traditionally, for object-oriented programming, aggregate objects are responsible for storage and location of items contained within the aggregate. For example, an aggregate list of people would contain both a method to store the people within memory and a method to locate one or more people within the aggregate.

In one aspect, a method is provided for separating the dual functions of storage and location of information contained in a data structure. In another aspect, the aggregate objects store information in a list which is a non-limiting example, while a locator object is responsible for locating information stored in an aggregate. Referring to FIG. 5, composite 506 of type object[ ] 504 is an aggregate responsible for storage of data, while RootCCMLocator 520 locates information in composite 506 which is a property of RootCCM 502.

In one embodiment, aggregate composite 506 of type object[ ] 504 comprises an array where all object instances are stored in a data structure that is contained within a class. An array is one example of a data structure that is contained within the class. Non limiting examples of other data structures include trees, collections, hash tables, arrays, links lists, a single object, document object models (DOM), data structures composed from XML, composites and any combination thereof. Aggregate composite 506 is a property of RootCCM 502 that encapsulates at least one type of data structures where information is stored within the class. IPropertyEnhanced 510 is an Interface 508 that contains the interface aspects of an entity in the real world. Classes that realize an interface must implement logic for all elements defined within the interface. ActualValue 514 of type object 512 is a property of IPropertyEnhanced 510.

In one aspect, ActualValue 514 is capable of storing a value or a reference to a value. Further described in ActualValue 514 are the get 516 and set 518 scope used to access and set values. The get scope is the section of code within the property that is executed when the property is accessed or read from another area of code. The set scope is the section of code within the property that is executed when the property is assigned a value within another area of code.

RootCCMLocator 520 locates information within the aforementioned aggregate composite 506 which is a property of RootCCM 502. RootCCMLocator 520 uses itemToFind, 524 of type string 522 to locate specific object instances contained within composite 506. ActualValue 526 implements the property ActualValue 514 in interface IPropertyEnhanced 510. When ActualValue 526 is accessed in another area of code, scope get 528 is executed. Scope get 528 contains the code required to locate, in this case, a single item within composite 506. Composite 506 is setup to store an item based on a string. Locating an item within the array is done using itemToFind 524.

Scope get 528, when accessed, gets a reference to the current thread using ThreadManager 402. ThreadManager 402 contains a property memory 438 which is an instance of RootCCM 502. RootCCM 502 contains composite 506. The brackets [ ] represent a location within composite 506 referenced using itemToFind 524.

In another aspect, when ActualValue 526 is set in another area of code, scope set 530 is executed. Scope set 530 contains the same code logic to locate a single item within composite 506. However, once the item is found, it is updated. In one aspect, value 532 is an implied parameter automatically provided by the programming language. The value 532 contains information passed automatically when ActualValue 526 was set somewhere else in the program. For example, to assign a value of “X” for ActualValue 526, the following code is used: iRootCCMLocator.actualValue=X.

Another non-limiting example provided is a comma separated value file (CSV File). The data structure of a CSV file is well known containing a line of information separated by commas. A new line in the file represents a new row of similar information. A CSV file centric CCM class is created containing a CSV data structure (called CsvCCM for this example). An associated locator is created that can be used to locate information within the CSV CCM (called CsvCCMLocator for this example). The CsvCCM contains two properties int dataToFindRow and string dataToFindColumn. The logic to locate an item within the CsvCCM for actualValue would be: return CsvCCM.goToRow(dataToFindRow).goToColumn(dataToFindColumn).

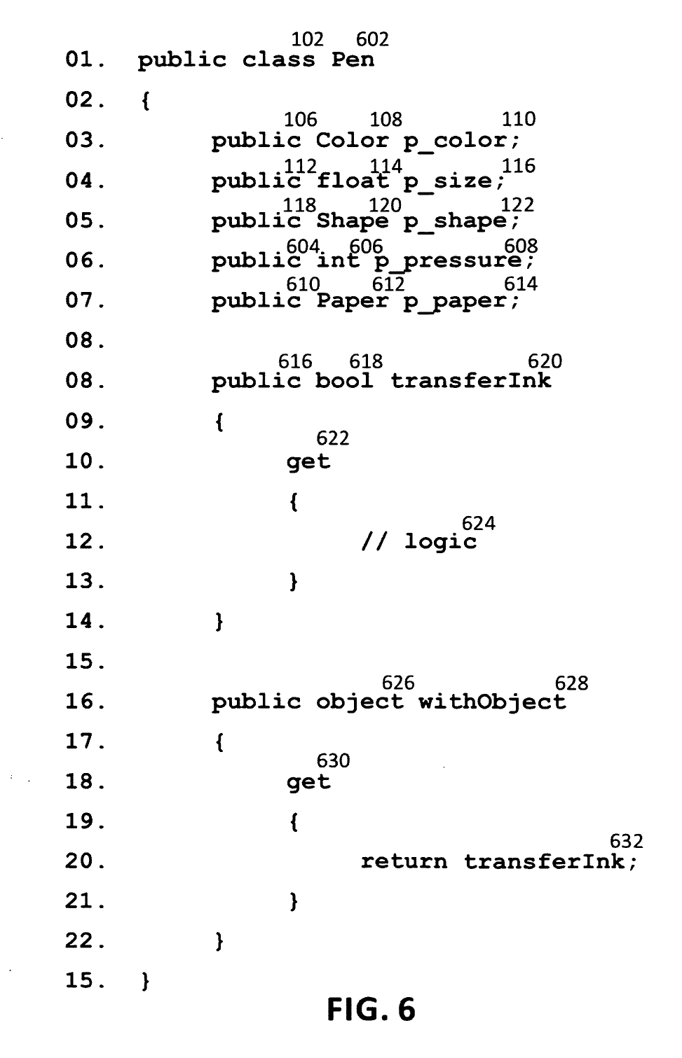

Referring to FIG. 6, Pen 104 represented as prior art is described as Pen 602 using the current invention. Pen 602 still contains similar properties p_color 110 of type 108, p_size of type 116 and p_shape 122 of Shape 120. Added to Pen 602 are additional properties p_pressure 608 of type int 606 which represents the pressure that is used when writing with Pen 602. Further, property p_paper 614 of type Paper 612 represents the paper that Pen 602 will be writing on. The biggest change is that transferInk 128 of Pen 104 is now a property transferInk 620 of Pen 602. transferInk 620 is now supported using a property as opposed to a method. transferInk 620 now has get 622 which executes logic 624.

Still Referring to FIG. 6, a standardized interface is possible by providing a common property for executing primary behavior of an object. The primary behavior of Pen 602 is transferInk 620 which executes logic 624. In this example, the purpose of the transferInk 620 is to transfer ink from Pen 602 to p_paper 614 of type Paper 612. This primary behavior transferInk 620 can also be executed by access withObject 628 with return type object 626. Within the program withObject 628 is accessed causing scope get 630 to be called. Within scope get 630 the primary behavior transferInk 632 is called as can be seen by Line 20. A person skilled in the art realizes the name of the property providing common access can be any description: withObject is just one of a plethora of possible names to use.

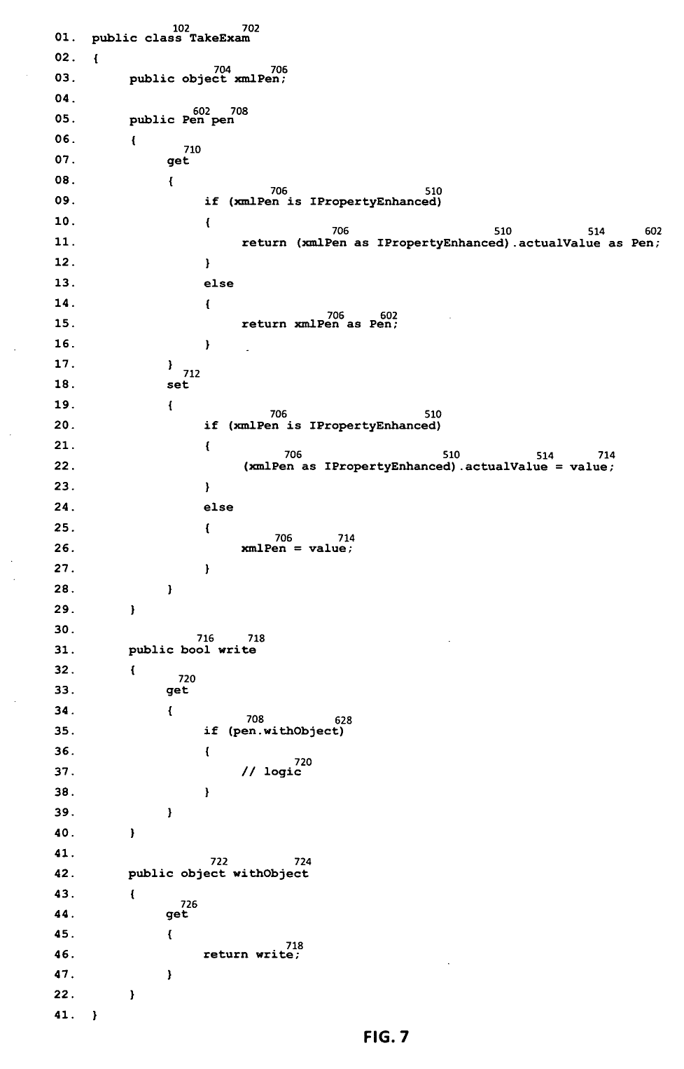

Referring to FIG. 7, properties can store a value or the location of the value within the CCM. TakeExam 702 represents a process by which an exam is taken. Of course, one experienced in the arts would realize that any business domain example could be used to show how a property can store a value or location of a value within CCM. We have arbitrarily chosen the take exam process. xmlPen 706 of type object 704 is an attribute which will eventually store an instance of a Pen 602. Pen 708 is a property of type Pen 602. pen 708 contains a scope get 710 and a scope set 712. When the pen property is read from within another part of the program, using for example Pen iPen=iTakeExam.pen, then scope get 710 is called. As defined in FIG. 7, scope get 710 determines if the value is located in the CCM, and whether it should be read from the CCM or whether the xmlPen contains a property which contains the actual pen value. Line 09 checks if xmlPen 706 is an IPropertyEnhanced 510. If the check is true then Line 11 is executed. If the check is false then line 15 is executed.

Still referring to FIG. 7, if xmlPen 706 is an IPropertyEnhanced 510 then Line 11 is executed. In this case, xmlPen 706, which is of type object 704, is converted to an IPropertyEnhanced 510. activeValue 514 of type object 512 is converted to a Pen 602 and returned. In this case, the value of the property was located somewhere in CCM. However, if xmlPen 706 is not an IPropertyEnhanced 510 as is checked in Line 11, then the information is located within xmlPen 706. Line 15 simply converts xmlPen706 of type object 704 into a Pen 602 and returns that to the calling program.

Still referring to FIG. 7, when scope 712 of pen 708 property of TakeExam 702 is set then the logic in Lines 20 through 27 is executed. Line 20 is logically equivalent to Line 09. When xmlPen 706 is an IPropertyEnhanced 510 then the logic in Line 22 is executed. In this case, xmlPen 706 is converted to an IPropertyEnhanced 510 and actualValue 514 is set to implied parameter value 714. In the case where Line 20 xmlPen 706 is not an IPropertyEnhanced 510 then the logic in Line 26 is executed. In this case, xmlPen 706 is simply assigned to value 714.

Still referring to FIG. 7, lets see how we are able to use pen 708 to return or use a Pen 602 from CCM or from xmlPen 706. TakeExam 702 has write 718 of type bool 716. The intent of write 718 is that it will write the exam. Again, this is only an example being provided to show how a property can contain an actual value or the location in CCM of a value. When write 718 is accessed in another part of a program get 720 is called. Line 35 logic is executed which consists of calling withObject 628 of pen 708. Looking closely at the example, pen 708 is a property of TakeExam 702. As explained above, this means that the instance of the Pen 602 used could be located within xmlPen 706 or located somewhere in CCM. It is easy to see then that pen 708 property is an enhanced property. Finally, if withObject 620 was successful then logic 720 is executed.

Still Referring to FIG. 7, a standardized interface is possible by providing a common property for executing primary behavior of an object. The primary behavior of TakeExam 702 is write 718. In this example, the purpose of the write 718 is to write a test using withObject 628 of Pen 602. This primary behavior, write 718, can also be executed by access withObject 724 with return type object 722. Within the program withObject 724 is accessed causing scope get 726 to be called. Within scope get 726 the primary behavior write 718 is called as can be seen by Line 46. Anyone experienced in the arts realizes the name of the property providing common access can be any description: withObject is just one of a plethora of possible names to use.

### EXAMPLE 1

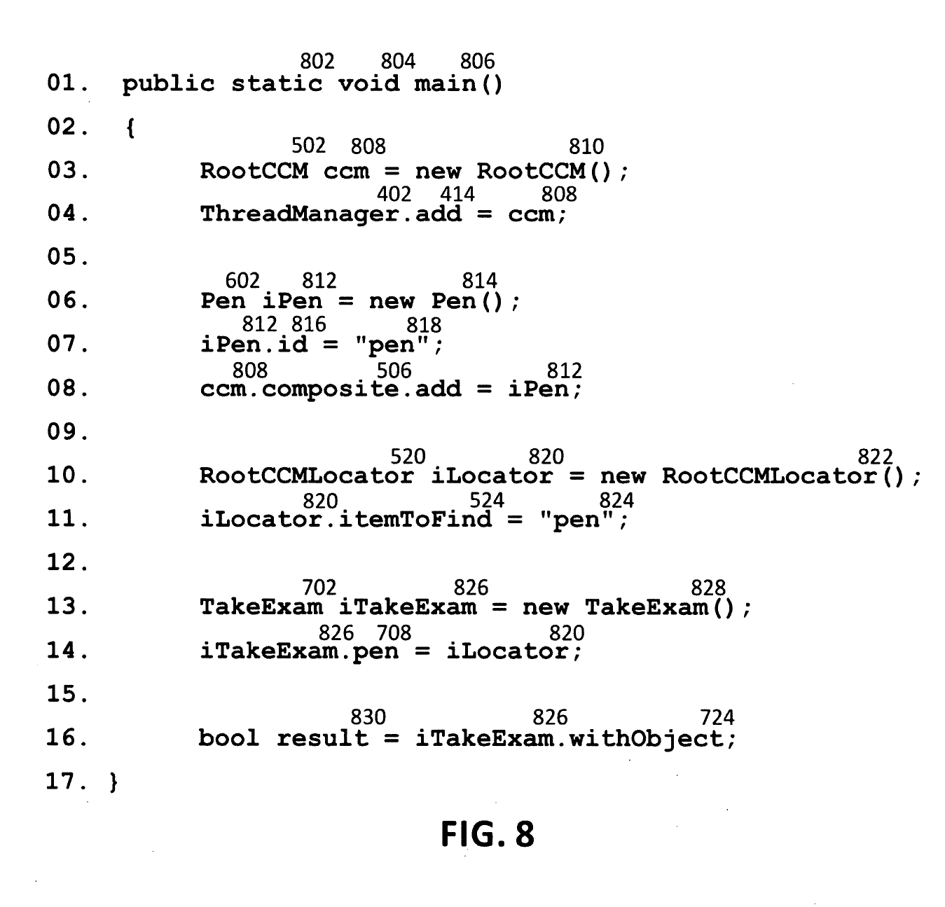

FIG. 8 depicts an application of the methods discussed herein. A static 802 Main 806 which returns void 804 is declared. Main 806 is a standard way by which a program describes the entry point into a program from an operating system. However, the name doesn't have to be main nor does it need to return a void 804 and so on. One experienced in the arts will simply recognize Line 01 as an entry to a program.

Ccm 808 is of type RootCCM 502 created through constructor RootCCM( ) 810. Ccm 808 is added to ThreadManager 402 through add 414. After ccm 808 is added to ThreadManager 402 a pen is created and added to CCM starting at Line 06. iPen 812 of type Pen 602 is created by calling constructor Pen( ) 814. iPen 812 has property id 816 which is assigned a string with the value of “pen” 818. iPen 812 is then added to composite 506 of the ccm 808. iLocator 820 of type RootCCMLocator 520 is created by calling constructor RootCCMLocator( ) 822. itemToFind 524 or iLocator 820 is assigned a string value of “pen” 824. It is not a coincidence that “pen” 824 is the same as “pen” 818. The logic of FIG. 5 shows that a comparison of these two values is used to find iPen 812.

iTakeExam 826 of type TakeExam 702 is created by calling constructor TakeExam( ) 828. pen 708 of iTakeExam 826 is set to iLocator 820. This means that pen 708 is now containing a reference to iPen 812 found through iLocator 820 and not the actual iPen 812. Of course, anyone experienced in the arts could see that we could have easily set pen 708 of iTakeExam 826 to iPen 812. However, this is one example of many describing how a property within the invention can be an actual value or the reference to an actual value in CCM. In this case, the CCM is ccm 808 and the value we will find is iPen 812 which was added to composite 506 of ccm 808.

Still referring to FIG. 8, withObject 724 of iTakeExam 826 is called and the result placed in result 830. The logic executed by withObject 724 is described in FIG. 7 in detail.

In another aspect, all objects used for a given process must be fully initialized before that process can execute. For example, with respect to iLocator 820, any properties of said locator object have to be setup before withObject 724 is accessed. In a further aspect objects are initialized by serialization. As used herein, objects are persistable: i.e. they are serializable. Effectively, all properties of all object instances have a known initial state that is set through serialization. For example, the locator object iLocator 820 contains a locator that is able to locate the specific pen required. This property can be persisted, in any suitable format, such as xml, json, yaml, binary, etc., and later serialized to the actual object instance. In a further aspect, an entire application can be persisted. During the initial run of an application, the entire application can be serialized and then executed. At any time, during program run-time, the memory can be persisted. This effectively lets a developer capture the status of the entire program at anytime. In a further aspect, persistence of an entire software application is possible because objects have an initial state and all method signatures are standardized.

### EXAMPLE 2

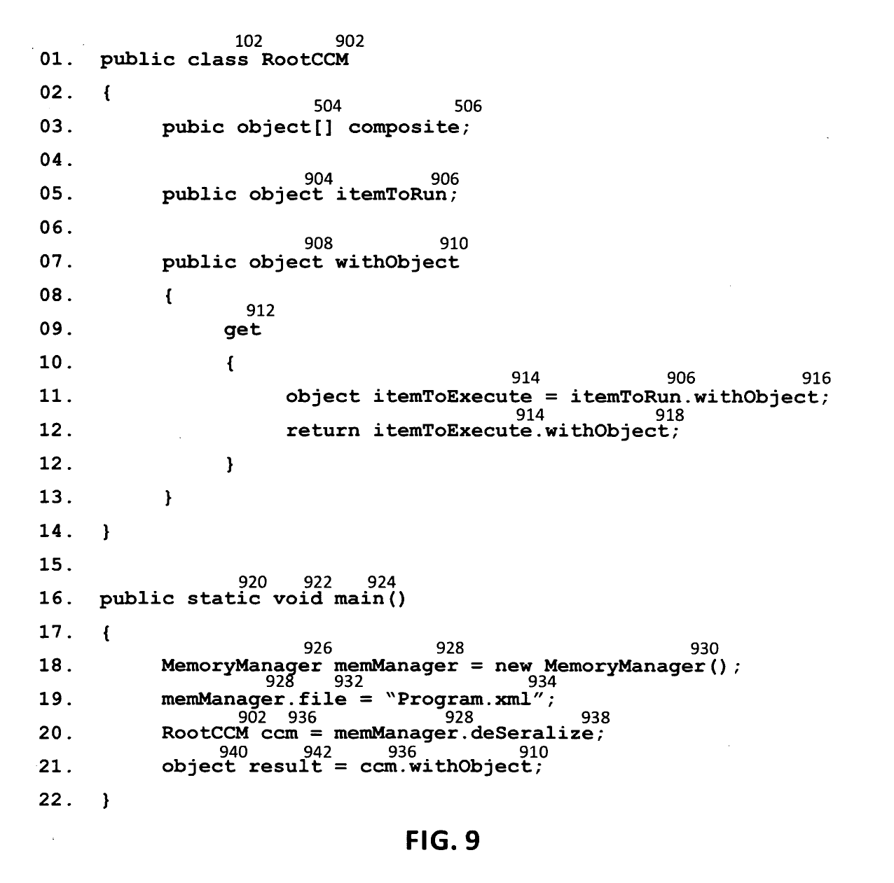

Referring to FIG. 9, RootCCM 502 has been further described in RootCCM 902. Composite 506 of type object[ ] 504 is an aggregate responsible for storage of data exactly similar as that described in FIG. 5. itemToRun 906 of type object 904 contains the necessary configuration to decide what action to take when withObject 910 is called. Specifically, this logic is described in scope get 912. withObject 910 of type object 908 is providing the common access behavior for RootCCM 902. Starting with Line 11, withObject 916 is called on itemToRun 906 and the resulting object is set in itemToExecute 914. The value of itemToRun 906 could be an instance of any object. Based on existing examples, itemToRun 906 could be an instance of Pen 602, TakeExam 702 or even RootCCM 902. Line 12, withObject 918 of itemToExecute 914 is called and the result returned. Once again, the result object in itemToExecute 914 could be an instance of any object including, but not limited to, example objects Pen 602, TakeExam 702 or RootCCM 902.

Further referring to FIG. 9, a static 920 Main 924 which returns void 922 is declared. Main 924 is a standard way by which a program describes the entry point into a program from an operating system. However, the name doesn't have to be main nor does it need to return a void 922 and so on. One experienced in the arts will simply recognize Line 16 as an entry to a program.

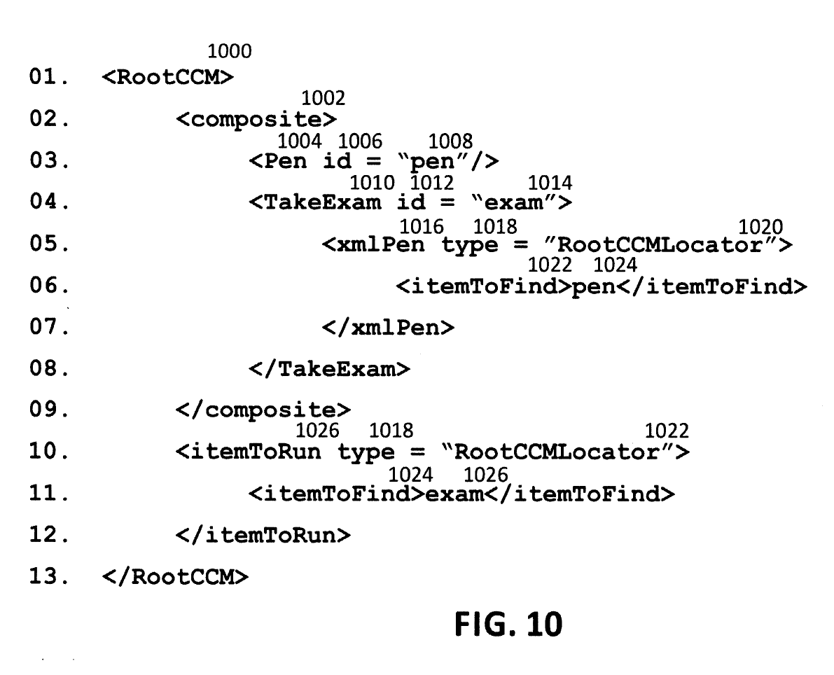

memManager 928 of type MemoryManager 936 is created by calling constructor MemoryManager( ) 930. File 932 of memManager 928 is set to value Program.xml 934. The contents of Program.xml 934 are described in detail in FIG. 10. One experienced in the arts will note that other non-limiting object serialization formats including json, protobuf, flat file, binary or yaml could have been used. Xml was simply chosen as the example.

Further referring to FIG. 9, an instance ccm 936 of type RootCCM 902 is created by calling deSeralize 938 of memManager 928. One experienced in the arts will realize that the solution of serialization and deserialization is well known. As such, the details of deSeralize 938 of MemoryManager 926 are not provided. deSeralize 938 takes the xml data located in file Program.xml 934 and converts it to object instances. Finally, withObject 910 of ccm 936 is called causing scope get 912 to be accessed and associated logic.

FIG. 10 depicts the Xml which represents the configuration or settings of all objects leading to the same objects and logic provided in FIG. 8. In this example, the structure of an exemplary CCM is described using XML. Other non-limiting object serialization formats include json, protobuf, flat file, binary or yaml could have been used. A deseralizer is able to read the xml data and turn the xml into an instance of CCM. RootCCM XML 1000 instructs the deseralizer to create a CCM such as RootCCM 902 depicted in FIG. 9. Composite XML 1002 represents composite 506 of FIG. 9. Composite XML 1002 contains two xml definitions: XML Pen1004 and XML TakeExam 1010. Composite XML 1002 instructs the deserializer to create an array of objects. Pen XML 1004 instructs the deseralizer to create an Pen 602 with an id 1012 of value “pen” 1014. TakeExam XML 1019 instructs the deseralizer to create TakeExam 702 with an id 1012 of value “exam” 1014.

Further referring to FIG. 10, xmlPen XML 1016 instructs the deseralizer to populate xmlPen 706 with an Object RootCCMLocater 520. RootCCMLocator XML 1020 and type XML 1018 instruct the deseralizer to create an object RootCCMLocator 520. itemToFind XML 1022 instructs the deseralizer to populate itemToFind 524 with a value of “pen” 1024. This configures Object RootCCMlocator 520 to look for an item named “pen” in the Composite 506. itemToRun XML 1026 instructs the deseralizer to populate itemToRun 906 with an Object RootCCMLocater 1022. RootCCMLocator XML 1022 and type XML 1018 instruct the deseralizer to create an object RootCCMLocator 520. itemToFind XML 1024 instructs the deseralizer to populate itemToFind 524 with a value of “exam” 1026. This configures Object RootCCMlocator 520 to look for an item named “exam” in the Composite 506.

### EXAMPLE 3

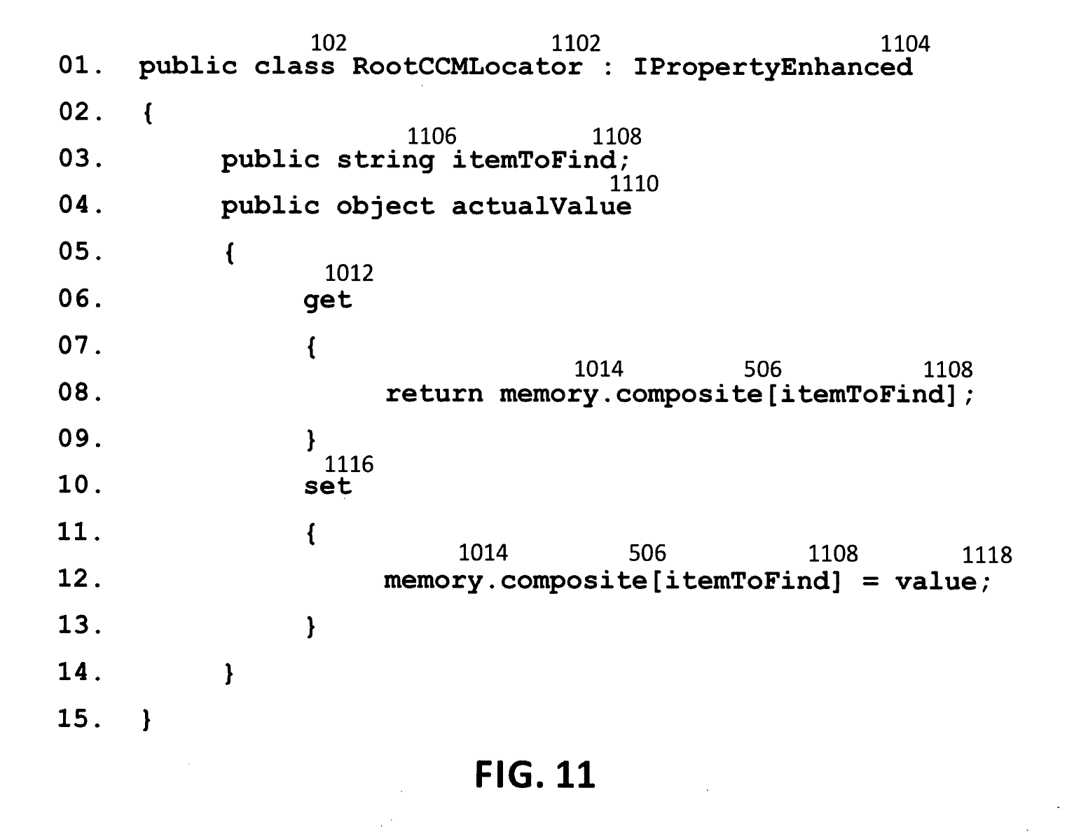

Referring to FIG. 11, another approach to access of CCM within properties is provided. The contents of FIG. 11 relate to RootCCMLocator 1102 are logically similar to the contents of FIG. 5 RootCCMLocator 502. In FIG. 05, access to CCM is done through ThreadManager 402. In another aspect of the present invention, access to CCM is provided by an implied parameter. Memory 1014 is an implied parameter passed to actualValue 1110. Value 1118 is also an implied parameter to actualValue 1110.

When accessing scope get 1012 within a program, implied parameters memory 1014 is passed to property actualValue 1110. Memory 1014 provides access to RootCCM 502. Line 08 of FIG. 11 is logically similar to Line 18 FIG. 5. When accessing scope set 1116, implied parameters value 1118 and memory 1014 are passed to property actualValue 1110. Line 12 of FIG. 11 is logically similar to Line 22 FIG. 5. In both cases, ThreadManager 402 is no longer required to obtain access to CCM.

### CCM Memory

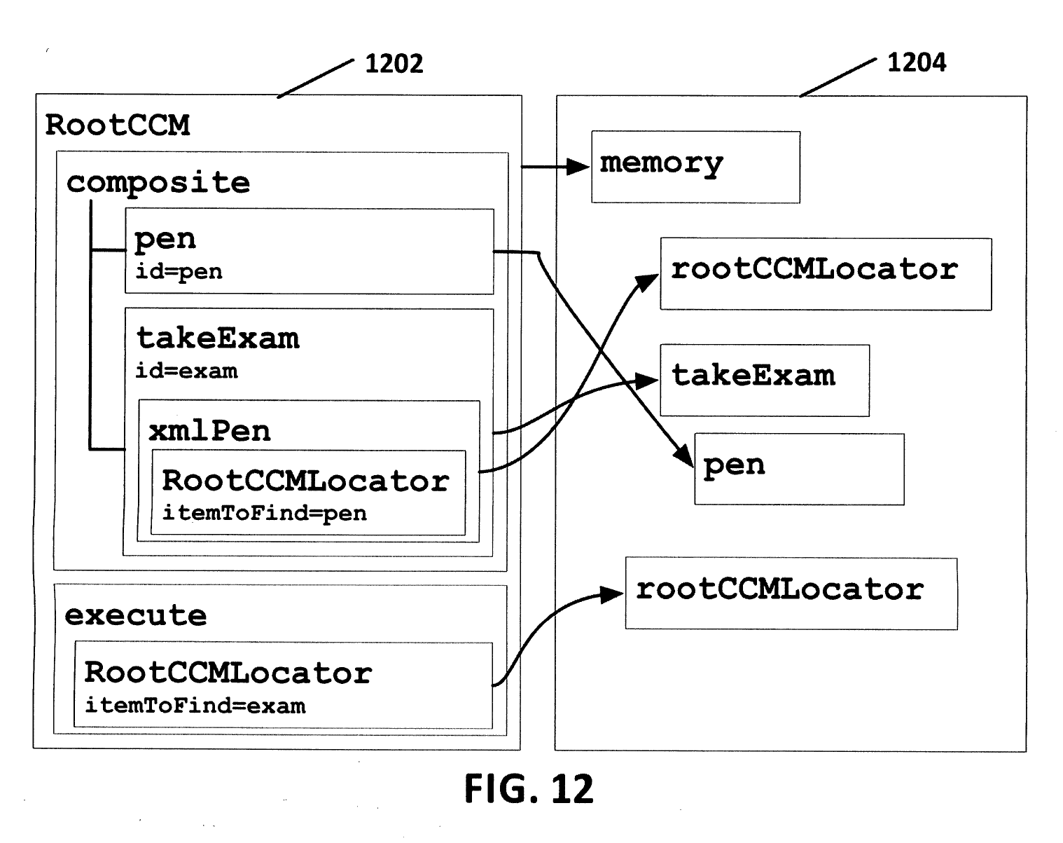

Referring to FIG. 12, instead of using parameters to transfer required external information to a method, a single reference to a CCM is available using the current thread context. All information within the program is logically structured within this memory. All objects are placed in the CCM 1202. The CCM 1202 is not the heap 1204 but the structuring of objects instances within the program. Referring to FIG. 12, references to object instances, which are located on the heap, are logically arranged and structured within the CCM 1202. Locators can find information within this structured memory. The heap 1204 contains instances of objects created by a memory manager through the “new” operator. The standard heap memory, used in most languages, generally contains no structure.

In still a further aspect, CCM data structure and data formats can reside in two areas of memory within the CCM: public instance and shared (static). For the public instance, CCM structures and formats are specific to each CCM instance and/or thread instance. For the shared static, CCM structures and formats are shared across the entire software application. Any structure or data formats located in the shared static areas of the CCM are directly accessible as instance variable using standard object orientated methods from anywhere in the program. Non-limiting examples of two different types of CCM being accessed from anywhere in the code include: CCMCIass.StaticData; and CCMMixed.StaticData.

Generally different methods can be used to access the CCM at different levels of the computing system. In one aspect, support for access of CCM within source code is done at the source code level. Thus, CCM can be supported without any changes to the operating system, hardware or programming language.

In still a further embodiment, the support for access of the CCM within the source code is done by making changes to the programming language, thus allowing for access to the CCM. In another embodiment, support for access of the CCM within the source code is done within the operating system and its threading/process model. In another aspect, changes are made to the process control block of the hardware or operating system. Context switching automatically provides access to the process/thread specific CCMs.

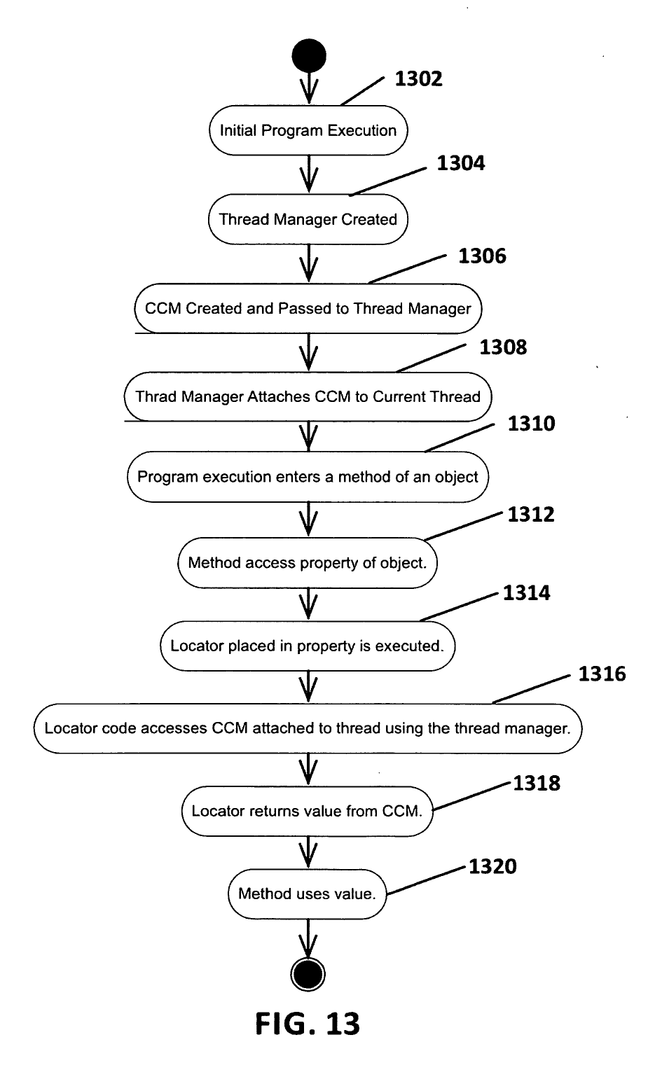

FIG. 13 demonstrates how external information is passed to a method via a CCM instance utilizing a thread manager. This example starts with initial execution of a program in Step 1302. A thread manager object is created in Step 1304. A CCM instance is created in Step 1306 using serialization and provided to thread manager. In Step 1308, the thread manager attaches the CCM instances to the current thread. At some time within program execution an object class with a standardized method signature as described previously will be executed. Typically in Step 1310 a program execution enters method of an object. The method accesses the property of the object in Step 1312. When external information is required a locator placed in the property is executed in Step 1314. The locator code accesses the CCM attached to a thread using the thread manager in Step 1316. In Step 1318 the locator returns the associated value from the CCM and passes that value to the method in Step 1320.

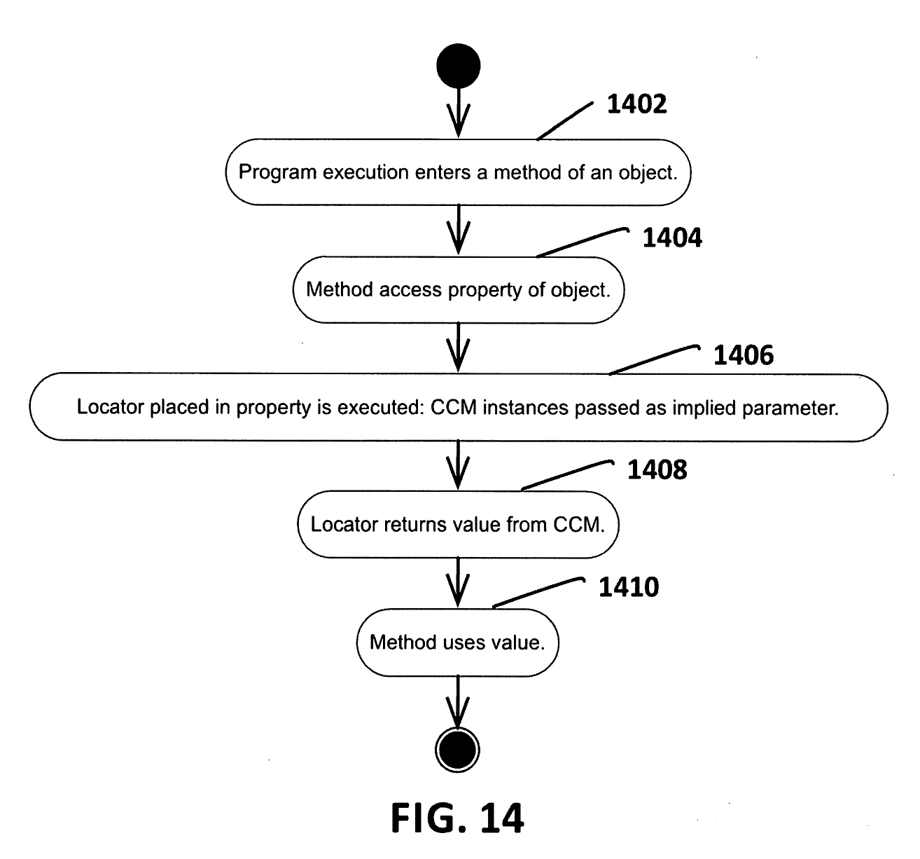

In another aspect, FIG. 14 demonstrates the process of passing external information to a method using an implied parameter. The program execution enters the method of an object in Step 1402. The method accesses the property of the object in Step 1404. If external information is required then the locator placed in the property is executed and the CCM instances are passed as an implicit parameter in Step 1406. The locator returns the value from the CCM in Step 1408 and passes that value to the method in Step 1410. An actual example of logic flow in FIG. 14 was described in detail in FIG. 11.

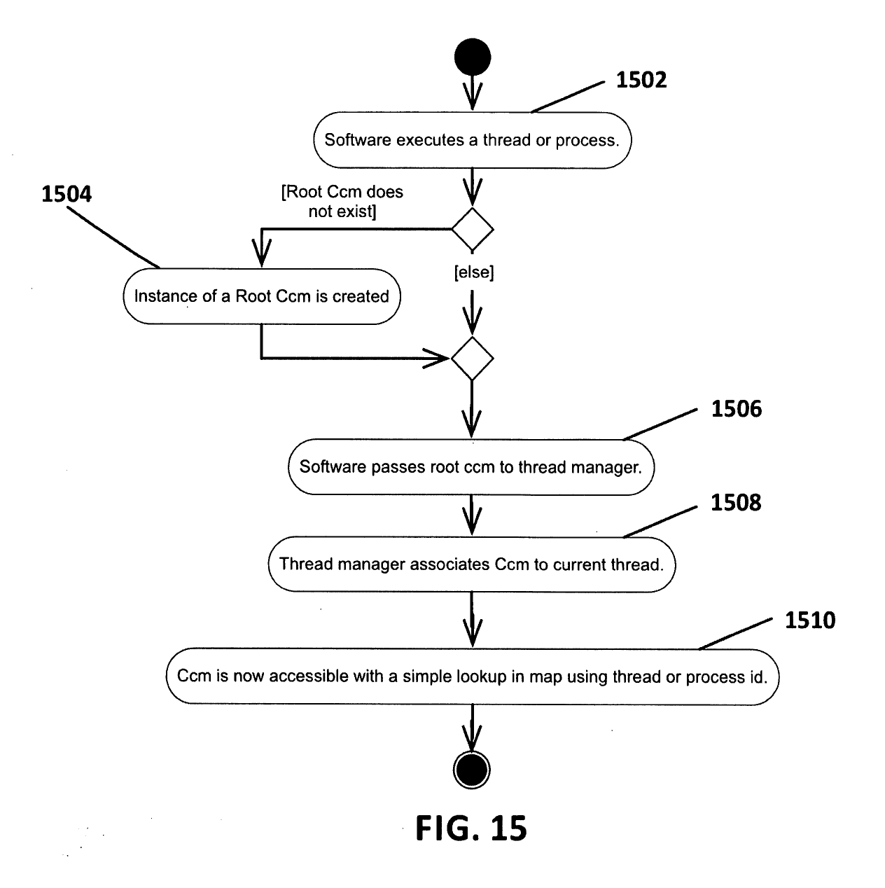

In still a further aspect, FIG. 15 demonstrates the mapping of a RootCCM with a current thread or process. Generally one or more CCM public instances are stored in a hash table or other data structure. New CCM instances are associated with one or more threads. The current CCMs can then be chosen by doing a lookup of current CCMs associated or mapped to a particular thread. In Step 1502 the software executes a thread or process. If a RootCCM does not exist then an instance of the RootCCM is created in Step 1504. In Step 1506 the software passes the RootCCM to the thread manager. The thread manager then maps or associates the RootCCM to the current thread in Step 1508. In Step 1510 the CCM is now accessible with a lookup map using the thread or process identification. A detailed implementation of the process flow described in FIG. 15 is provided in FIG. 4.

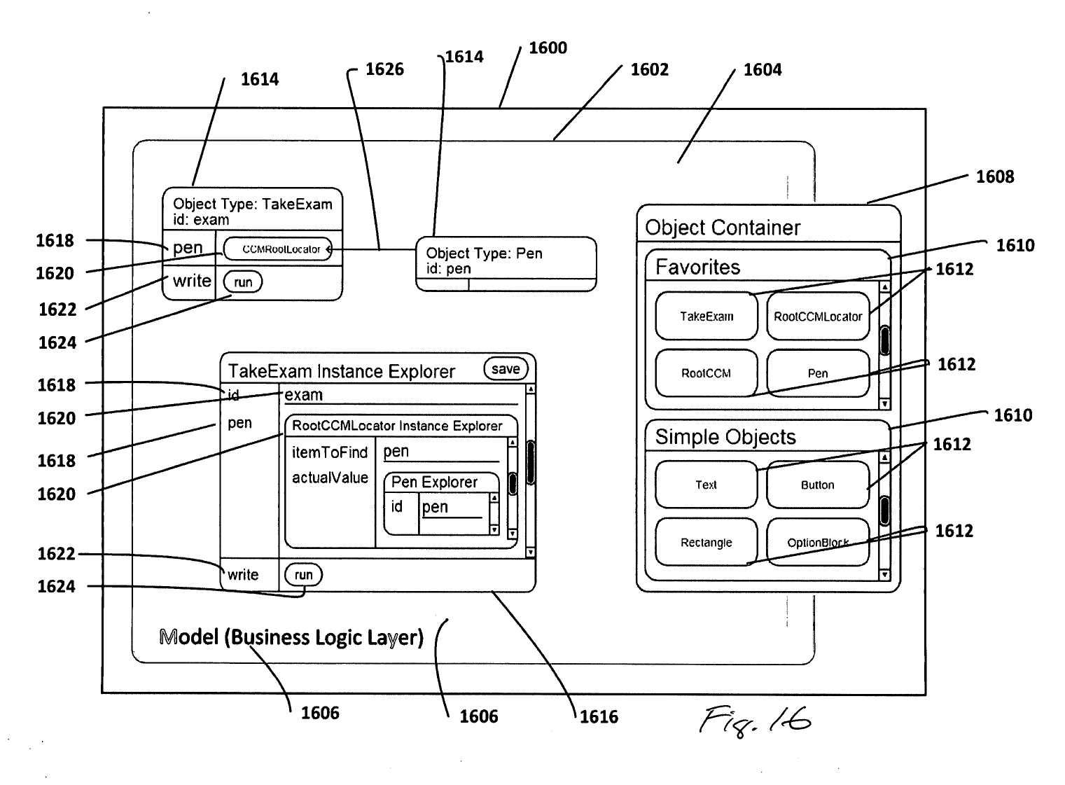

In still another aspect, FIG. 16 demonstrates how to visually define a software system using simplified objects. Interface devices 1600 are one or more devices able to display graphical images generated by a one or more computing devices and optionally provide input to said computing devices. Such display devices are common and attached to or integrated into computer systems, portable computer systems, pads, personal devices, cell phones, laptops, etc.

Logical interface layer 1602 and 1604 represents areas displayed on physical interface devices 1600. Logical interface layers 1602 and 1604 are layered: one being displayed behind the other. Through interaction, logical interface layers 1602 can be rotated bringing one to the front and moving the other further back in the interface devices 1600. As an example, bringing logical interface layer 1604 in front of logical interface layer 1602 could be done through gestures on the interface devices 1600 when said device supports gestures. One could further cycle between logical interface layers using a tab key on a keyboard on any other key combination. Other means of rotating logical interface layers 1602 are within the scope of one of ordinary skill in the arts.

Logical interface layers 1602 and 1604 represents a logical grouping of software system behavior within interface devices 1600. Logical interface layers 1602 and 1604 have associated with them associated layer description 1606. In this example, logical interface layer 1602 has an associated layer description 1606 of “Model (Business Logic Layer)” and logical interface layer 1604 has an associated layer description 1606 of “Persistence (Data Storage Layer)”.

Any number of additional logical interface layers 1602 may be added dynamically to physical interface devices 1600 representing other logical aspects of the software system under development. Examples of such logical interface layers are user interface layers, user interface logic layers, database layers, network communication layers, etc. The arrangement of logical interface layers 1602 and 1604 do not have to be stacked. Logical Interface Layers 1602 and 1604 could also be displayed next to each other.

Object container 1608 is a logical interface used to display available simplified objects 1612 contained in dynamic groups 1610. Dynamic group 1610 represents logical or defined group of simplified objects 1610 and provided a description. In the example, a dynamic group 1610 is provided that represents a logical group of simplified objects 1612 that are Favorites defined by the user of the system. In another example, dynamic group 1610 contains all other simplified objects 1612 defined. Dynamic groups 1610 are not limited to these groups and can be created by the user of the system or created logically. Examples are but not limited to All Simplified Objects, Most Used, Visual Objects, Database Objects, and so on.

Visual instances 1614 are visual representation of an instance or copy of a simplified object 1612: in this example a Take Exam and Pen. The creation of visual instance 1614 can be done in various ways. Usually, a simplified object 1612 is first selected. Different methods of selection include a mouse, tabbing to a simplified object 1612, selecting a simplified object 1612 using a touch sensitive physical interface and selecting simplified object 1612 with a stylus or finger. For example, the selected simplified object 1612 is dragged to a location on logical interface layer 1602 where the visual instance 1614 should be created. In another process, on physical interface devices 1600 that support multi touch, a point on logical interface layer 1602 is selected by a second stylus or finger representing the location where the visual instance 1614 should be created. A visual instance 1614 is then created. This process can be repeated indefinitely choosing from any simplified object 1612 located in object container 1608.

In one aspect, selecting a visual instance 1614 causes instance explorer 1616 to populate with the details of the visual instance 1614. Instance explorer 1616 is also a visual representation or copy of a simplified object 1612. The difference between visual instance 1614 and instance explorer 1616 is purpose. Visual instance 1614 is a visual instance or copy of a simplified objects 1612 contained on a logical interface layer 1602. Instance explorer 1616 can be located anywhere within physical interface device 1600 and, as stated already, contains the properties of the currently selected visual instance 1614.

Visual instances 1614 and instance explorer 1616 contain visual properties 1618, visual property values 1620, visual methods 1622 and visual method action 1624 which provide further information visually about a simplified object 1612. Each visual property 1618 has an associated visual property value 1620. For example, visual property 1618 is a pen with an associated visual property value 1620 of a CCMRootLocator. Each visual method 1622 has an associated visual method action 1624. For example, visual method 1622 write has an associated visual method action 1624 run.

Within instance explorer 1616, visual property 1618 has its visual property value 1620 expanded to a visual instance explorer 1616. This means a visual property value 1620 can display a simple value like a string or it can display a complete visual instance explorer 1616.

Continuing with FIG. 16, recall that a property of a simplified object 1612 can contain a value or a reference to a value within composite centric memory. This is represented visually as seen where visual locator instance 1626 shows a relationship between two visual instances 1614 TakeExam and Pen. The creation of visual instances 1614 was done through the process described above. Creation of visual locator 1626 can be done using different approaches. In one approach, a mouse device can be used to select a source visual instance 1614 or a source visual property 1418 and then select a destination visual property value 1620. In the example in FIG. 16, a user would have selected visual instance 1614 pen and then selected visual property value 1620 pen of visual instance 1614 TakeExam.

In the case where interface device 1600 provides a touch sensitive input a user can physically touch visual instance 1614 pen and then physically touch visual property value 1620. In another case, where physical interface device 1600 is a multi-touch input device, a user can physically touch visual instance 1614 pen with one finger or stylus and then touch visual property Value 1620 with another finger or stylus.

In all cases, a visual locator instance 1626 is created and visually drawn between the two selected items. Anyone experienced in the arts can understand the basic concept behind connecting two simplified objects 1612 and other approaches of associating simplified objects are trivial.

### Conclusion

Other variations, applications and ramifications of the present invention will occur to those skilled in the art upon reading this disclosure. Those are intended to be included within the scope of this invention, as defined in the appended claims.

What is claimed is:

1. A computer implemented method for simplified object oriented programming comprising:
a. defining simplified objects with no public methods;
b. said simplified objects containing at least one public property capable of storing values or locators referencing values within said structured data objects;
c. defining structured data objects corresponding to said simplified objects;
d. associating said structured data objects with at least one current process thread;
e. defining locator objects corresponding to said simplified objects, wherein said locator objects find said simplified objects in said structured data objects,
f. wherein said simplified objects, said structured data objects and said locator objects are perisistable;
g. initializing said simplified objects, said structured data objects and said locator objects, and
h. accessing said simplified objects, said structured data objects and said locator objects.

2. The method of claim 1 wherein said properties comprises an implicit reference to said structured data objects.

3. The method of claim 2 wherein said structured data object is selected from the group consisting of trees, collections, hash tables, arrays, links lists, a single object, document object models (DOM), XML data structures, aggregates, hashes, composites or any combination thereof.

4. The method of claim 3 wherein said initializing comprises of deserialization of said structured data object.

5. The method of claim 4 wherein the value of said structured data objects are provided through an association between a current process thread and said structured data objects.

6. The method of claim 4 wherein said structured data object has corresponding locator objects.

7. A computer implemented method for simplified object oriented programming in a visual programming environment comprises:
a. using simplified objects, in a graphical user interface, with no public methods;
b. using structured data objects, in a graphical user interface, corresponding to said simplified objects;
wherein said simplified objects contain properties capable of storing values or locators referencing values within said structured data objects.
c. associating said structured data objects, in a graphical user interface, with at least one current process thread;
d. defining locator objects, in a graphical user interface, corresponding to said simplified objects, wherein said locator objects find said simplified objects in said structured data objects,
e. wherein said simplified objects, said structured data objects and said locator objects are perisistable;
f. initializing said simplified objects, said structured data objects and said locator objects in a graphical user interface; and
g. accessing said simplified objects, said structured data objects and said locator objects in a graphical user interface.
h. associating said simplified objects, said structured data objects and said locator objects in a graphical user interface, with other simplified objects, structured data objects and locator objects.

8. The method of claim 7 where said association of simplified objects is done by first selecting the property of one simplified object and populating it with a reference to other said simplified object or reference to a property of other said simplified object.

9. The method of claim 8 where said association is done by first visually touching a property of a destination simplified object on a touch screen device and then visually touching a visual object instance of a source simplified object.

10. The method of claim 8 where said association is done by dragging a source simplified object into the property of a destination simplified object.

11. The method of claim 9 where said association process of simplified objects causes a new locator object instance to be created, referencing source simplified object, and stored in a destination simplified object property.

12. The method of claim 10 where said association process of simplified objects causes a new locator object instance to be created, referencing source simplified object, and stored in a destination simplified object property.

13. The method of claim 2 further comprises a get scope accessible during an equals get operation.

14. The method of claim 3 further comprises a set scope accessible during an equals set operation.

15. The method of claim 5 wherein the value of said structured data objects are provided by the access control block of a CPU.

16. The method of claim 1 wherein said simplified objects have no methods.

17. A computer implemented method for simplified object oriented programming comprising:
a. defining simplified objects with no public methods;
b. defining structured data objects corresponding to said simplified objects;
c. associating said structured data objects with at least one current process thread;
d. wherein said simplified objects, said structured data objects are persistable;
e. initializing said simplified objects and said structured data objects.
